(19) United States
(12) Patent Application Publication
(10) Pub. No.: US 2009/0167497 A1
(43) Pub. Date: Jul. 2, 2009

(54) TAG FOR RFID, WIRELESS TRANSMISSION SYSTEM AND METHOD FOR LARGE SCALE MULTIMEDIA CONTENTS USING THE SAME

(75) Inventors: Seon Wook Kim, Namyangju (KR); Young Sun Han, Seoul (KR)

Correspondence Address: RABIN & Berdo, PC, 1101 14TH STREET, NW, SUITE 500, WASHINGTON, DC, 20005, US

(73) Assignee: Korea University Industrial & Academic Collaboration Foundation, Seoul (KR)

(21) Appl. No.: 12/033,756

(22) Filed: Feb. 19, 2008

(30) Foreign Application Priority Data
Dec. 27, 2007 (KR) 10-2007-0139065

(51) Int. Cl. H04Q 5/22

(52) U.S. Cl. 340/10.1

(57) ABSTRACT

The invention provides an RFID tag for storing large scale multimedia contents data readable only when it is authenticated, remote authentication for accessing the multimedia contents data stored in the RFID tag, and a wireless communication system and method for transmitting/receiving the multimedia contents on a radio frequency through the authentication. Specifically, the tag includes: a wireless communication unit transmitting/receiving the first and second request signals and the first and second data signals; a first memory device storing first data for the first data signal; a second memory device storing second data for the second data signal; a tag control unit which generates and transmits the first data signal based on the first data in response to the first request signal from the reader device, or generates and transmits the second data signal based on the second data in response to the second request signal from the reader device; and an authentication unit selectively prohibiting the tag control unit from accessing the second memory device depending on authentication information contained in the second request signal.

### CROSS-REFERENCE TO RELATED PATENT APPLICATION

This application claims the benefit of Korean Patent Application No. 10-2007-0139065, filed on Dec. 27, 2007, in the Korean Intellectual Property Office, the disclosure of which is incorporated herein in its entirety by reference.

### BACKGROUND OF THE INVENTION

1. Field of the Invention

The present invention relates to a radio frequency identification (RFID) tag and a wireless communication system and method for large scale multimedia contents using the same, and more particularly, to remote authentication for accessing large scale multimedia contents data stored in the RFID tag and a wireless communication system and method for receiving the large scale multimedia contents using radio frequency communication.

2. Description of the Related Art

Generally, a radio frequency identification (RFID) is known as a field of automated data collecting technology on a radio frequency band for managing entity data such as humans, animals, and objects using electromagnetic or electrostatic coupling phenomena. In comparison with existing bar code systems, the RFID does not necessitate a separate scanning or near-contact operation. Furthermore, the RFID has many other advantages such as real-time administration of the entities, fast accurate identification of a plurality of entities, facilitating encryption and updating the data, semi-permanent lifetime, and resistance to attacks. Thus, the RFID is being highlighted as a next generation recognition technology applicable to a variety of industries.

In the RFID technology, a tag or transponder for storing data and a reader for reading data are indispensible. Typically, the tag having data appropriate to its use is implanted on an entity, and then, the data stored in the tag is recognized and read by the reader via wireless communication on a radio frequency band.

For this purpose, the tag has a memory device for storing the data, an integrated circuit (IC) chip having a control unit or the like for controlling communication, and a tag antenna for facilitating wireless communication. Also, the reader has a logic operation circuit such as a microprocessor for signal conversion and information authentication, and a reader antenna for facilitating wireless communication. The tag and the reader uses frequency bands ranging from a low-frequency band such as 150 KHz or lower to a microwave frequency band such as 5 GHz or higher (e.g., 125 KHz, 13.56 MHz, 860˜960 MHz, or 2.45 Ghz) for facilitating the wireless communication. Typically, general tags are classified into a active tag and a passive tag depending on whether or not there is a power source, or classified into a read-only tag, a write-once-read-many (WORM) tag, and a read/write tag depending on whether or not the data is rewritable.

On the other hand, as the RFID is widely spread in industries, efforts have been focused on fast data communication and processing for efficient entity management. As a result, the memory of the tag has been changed from an electrically erasable and programmable read only memory (EEPROM) to a ferroelectric RAM (FRAM) to reduce a write time duration to 1/100. Otherwise, the frequency band for communication between the tag and the reader has been widened to improve a communication speed, or the data processing algorithm has been changed from a binary tree type to an Aloha type.

Unfortunately, despite the aforementioned efforts, the RFID is still limitedly employed in a specific purpose such as entity identification. Furthermore, the amount of data that can be stored in the tag still remains in several Mbytes. Therefore, people still hesitate to use the RFID to store and manage multimedia contents such as videos, music, and data files for various common applications. Techniques for efficiently manage large scale multimedia contents using the RFID are not sufficiently present in the art.

### SUMMARY OF THE INVENTION

The present invention is contrived to solve the aforementioned problems, and proposes a method of efficiently managing large scale multimedia contents using a radio frequency identification (RFID) technology.

Specifically, the present invention provides a RFID tag which stores large scale multimedia contents data as well as allows the multimedia contents to be read only when a separate authentication process is successful. Also, the present invention provides a wireless communication system and method in which remote authentication is facilitated using a mobile terminal capable of Internet access, and then, the large scale multimedia contents stored in the RFID tag can be transmitted.

According to an aspect of the present invention, there is provided a radio frequency identification (RFID) tag transmitting first and second data signals in respond to first and second request signals transmitted from a reader device, the RFID tag comprising: a wireless communication unit transmitting/receiving the first and second request signals and the first and second data signals; a first memory device storing first data for the first data signal; a second memory device storing second data for the second data signal; a tag control unit which generates and transmits the first data signal based on the first data in response to the first request signal from the reader device, or generates and transmits the second data signal based on the second data in response to the second request signal from the reader device; and an authentication unit selectively prohibiting the tag control unit from accessing the second memory device depending on authentication information contained in the second request signal.

Preferably, the authentication information may be an authentication key including at least one of a tag ID and a contents ID; the authentication unit may allow the tag control unit to access the second memory device if there is the authentication key in the second request signal; and the authentication unit may prohibit the tag control unit from accessing the second memory device if there is no authentication key in the second request signal. In addition, the authentication unit may allow the tag control unit to transmit to the reader device an authentication request signal including at least one of a tag ID and a contents ID if there is no authentication key in the second request signal. The second data may be large scale multimedia contents data, and the first data may be identification data capable of identifying the multimedia contents data. The large scale multimedia contents data may be at least one selected from a group consisting of music, videos, pictures, and data files. The wireless communication unit, the first memory device, and the tag control unit may constitute a main body, the authentication unit and the second memory device may constitute an extended body, and the extended body may be connected to the main body in a detachable manner.

According to another aspect of the present invention, there is provided a wireless communication system for large scale multimedia contents using the RFID tag, the system comprising: a mobile terminal having: a reader device; an Internet communication unit for supporting access to the Internet; a reader control unit for controlling communication between the reader device and the tag; and a reader memory for storing the second data to be transmitted to the tag; and a server unit having: an electronic payment server connected to the mobile terminal via the Internet to support electronic payment using the mobile terminal; and an authentication server operated in connection with the electronic payment server to issue authentication information for the electronic payment and transmit the authentication information to the mobile terminal via the Internet.

Preferably, the mobile terminal may include at least one selected from a group consisting of a personal digital assistant (PDA), a notebook computer, and a mobile phone. The server unit may further comprise: a web server connectable to the mobile terminal to provide a webpage for the electronic payment; and a database operative in connection with the authentication server to store electronic payment information on the mobile terminal and a user of the mobile terminal.

According to still another aspect of the present invention, there is provided a wireless communication method of large scale contents using a mobile terminal having a reader device, a tag communicating with the reader device on a radio frequency signal for storing first and second data, and a server unit connected to the mobile terminal via the Internet to support electronic payment, the method comprising: (a) the tag storing the first and second data; (b) the reader device detecting the tag and transmitting a first request signal; (c) the tag transmitting a first data signal based on the first data in response to the first request signal; (d) the reader device transmitting a second request signal; and (e) the tag selectively transmitting the second data signal based on the second data depending on whether or not there is authentication information in the second request signal.

Preferably, the (e) transmitting the second data signal may include transmitting the second data signal based on the second data when there is the authentication information, or transmitting an authentication request signal when there is no authentication information. Also, when there is no authentication information in the second request signal, the (e) transmitting the second data signal may include: (f) connecting the mobile terminal to the server unit; and (g) the server unit generating the authentication key through the electronic payment using the mobile terminal, and transmitting the authentication key to the mobile terminal via the Internet.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a RFID tag according to the present invention;

FIG. 2 is a schematic diagram illustrating a wireless communication system of large scale multimedia contents using a RFID tag according to the present invention; and

FIG. 3 is a flowchart illustrating a wireless communication method of large scale multimedia contents using a RFID tag according to the present invention.

### DETAILED DESCRIPTION OF THE INVENTION

Hereinafter, the present invention will be described in more detail with reference to the accompanying drawings.

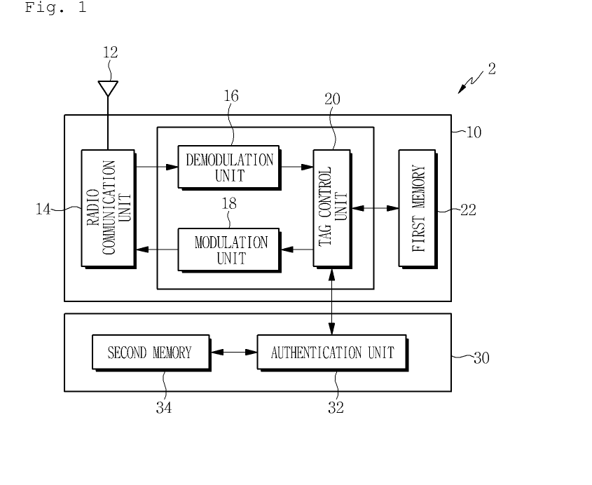

FIG. 1 is a block diagram illustrating a radio frequency identification (RFID) tag according to the present invention. For simplicity of description, it is assumed that the tag 2 is divided into a main body 10 and an extended body 30.

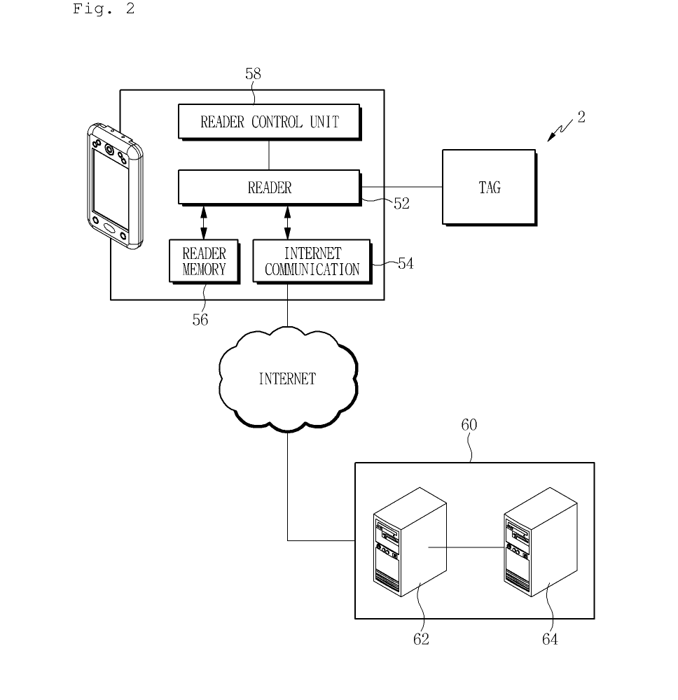

First, the main body 10 comprises: an antenna 12 for transmitting/receiving radio frequency band signals transmitted/received to/from internal or external components, including a signal transmitted from a reader device (refer to 52 of FIG. 2) as well as a signal transmitted from the tag 2; a wireless communication unit 14 connected to the antenna 12 for amplifying and/or filtering the transmit/receive signals to support robust wireless communication; a demodulation unit 16 for demodulating a signal received from the wireless communication unit 14 to convert the signal into appropriate digital data; a modulation unit 18 for converting digital data transmitted from the reader devise into a format appropriate to the wireless communication unit; and a tag control unit 20 for substantially controlling wireless communication between the tag 2 and the reader device by reading data required for first and second memory devices 22 and 24, described later, for the signal received from the demodulation unit 16 and generating first and second data signals and transmitting the first and second data signals to the reader device.

It should be noted that the main body 10 may be an active type having a separate power source as well as a passive type which uses induction current of the signal received from the antenna as a power source. Particularly, in the latter type, a charging means for charging induction current may be optionally provided.

In addition, the modulation and demodulation units 16 and 18, the tag control unit 20, and the first memory device 22 maybe packaged in an IC chip, and the first memory device 22 may be an EEPROM or FRAM having a size of several Mbytes.

The extended body 30 comprises an authentication unit 32 operative in connection with the tag control unit 20 and a second memory device 34 connected thereto and having a large scale.

It should be noted that the second memory device 34 may be a Flash memory capable of storing large scale data having a size of several Gbytes or higher. The authentication unit 32 will be described in detail later. The extended body 30 may be readily assembled or disassembled with or detachable to the main body 10. For this purpose, the extended body 30 and the main body 10 may be connected to each other using a USB connector capable of transmitting data and power or any other connectors.

On the other hand, the tag 2 having the above configuration according to the present invention may be used as a storage medium for multimedia contents. In this case, the first memory device 22 stores identification data of multimedia contents as a first data type, and the second memory device 34 stores multimedia contents data as a second data type. In other words, the second data stored in the second memory device 34 may include one or more pieces of large scale multimedia contents data such as music, videos, pictures, and data files executable by an operating system (OS) or an application program in a general information processing device such as a computer. The first data stored in the first memory device 22 may include identification data for identifying large scale multimedia contents data stored in the second memory device 34 using a general information processing device such as a computer. For example, the identification data may include a title having a text format for a music file, a title and/or a capture screen having an image format for an image file, a thumbnail having an image format for a photograph file, and a title having a text format and/or an icon for a data file.

The tag 2 according to the present invention generates and sends a first data signal based on first data in response to a first request signal, and generates and sends a second data signal based on second data in response to a second request signal. Preferably, the second request signal from the reader device includes an encrypted authentication key as authentication information for transmitting the second data. The authentication unit 32 examines whether or not there is an authentication key in the second request information, and selectively determines whether or not the tag control unit 20 accesses the second memory device 34.

As a result, the tag 2 according to the present invention is allowed to store and effectively manage large scale multimedia contents.

More specifically, FIG. 2 is a schematic diagram illustrating a wireless communication system of large scale contents using a tag 2 according to the present invention.

As shown in FIG. 2, the wireless communication system for large scale contents according to the present invention comprises: a tag 2; a mobile terminal 40 having a reader device 52 and capable of accessing the Internet; and a server unit 60 connected to the mobile terminal 40 via the Internet at a service provider side.

First, the mobile terminal 40 may be a portable electronic device such as a PDA, a mobile phone, or a laptop computer, and accessed to the Internet using an Internet communication unit 54 such as a wireless LAN card. Accordingly, the mobile terminal 40 comprises a touch pad for a PDA, a keypad for a mobile phone, or a keypad and a mouse for a notebook computer as an input device 42 for inputting user's selection and instructions, and a display screen 44 for displaying various data.

In addition, the mobile terminal 40 may comprise: a reader control unit 58 for controlling Internet communication with the server unit 60 via the Internet as well as wireless communication between the tag 2 and the reader device described later; and a reader memory device 56 for storing the second data transmitted from the tag 2. It should be noted that the reader control unit 58 may be mounted on a hard disk drive or the like for controlling unique operation of the mobile terminal in a software type. Also, the reader memory device 56 may be an internal memory integrated into the mobile terminal or an extended memory separately connected.

The, the server unit 60 comprises: an electronic payment server 62 which supports electronic payment using a mobile terminal 40; and an authentication server 64 which generates authentication information containing an authentication key and transmits it to the mobile terminal 40 when the electronic payment is successfully completed. It should be noted that the authentication information may contain a balance electronically charged by a user as well as an authentication key obtained by selectively combining, addition, or modifying a tag identification (ID) and a contents identification (ID). Optionally, a database that can operated in connection with the authentication server 64 may be prepared to store information on the authenticated mobile terminal 40 and/or its user's information. The server unit 60 may be implemented using skills known in the art with respect to electronic payment and generation/transmission of the authentication information.

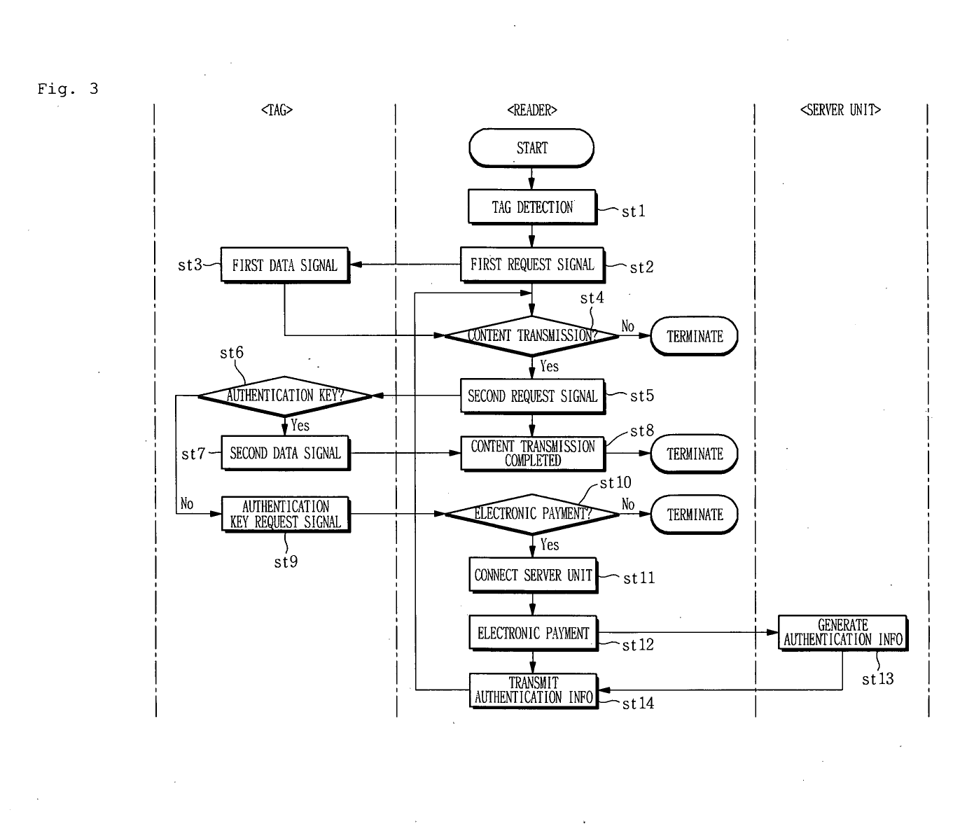

FIG. 3 is a flowchart illustrating a wireless communication method using a wireless communication system according to an embodiment of the present invention. Hereinafter, the wireless communication method will be described in detail with reference to FIGS. 1 to 3.

First, according to the wireless communication method of the present invention, the second memory device 34 of the tag 2 stores multimedia contents data corresponding to the second data, while the first memory device 22 stores identification data of the multimedia contents corresponding to the first data. The tag 2 may be displayed in stores, shops, or the like.

Then, when a user having the mobile terminal 40 comes within a communication range, the reader device 52 of the mobile terminal 40 detects the tag 2 (st1), and transmits a first request signal to the tag 2 (st2). Accordingly, the tag 2 generates the first data signal based on the first data stored in the first memory device 22 and responds to the mobile terminal 40 (st3). The user recognizes the first data stored in the first memory device 22 of the tag 2, i.e., identification data of the multimedia contents, through a display screen 44 of the mobile terminal 40. It should be noted that the identification data of the multimedia contents may include price information on the corresponding multimedia contents.

Subsequently, the user selects desired multimedia contents data using the mobile terminal 40 (st4), and the reader device 52 transmits to the tag 2 a second request signal for requesting the corresponding multimedia contents data.

Accordingly, the tag 2 generates the second data signal based on the second data stored in the second memory 34. During this process, the authentication unit 32 examines whether or not there is a valid authentication key within the second request signal (st6). If there is the authentication key, the tag control unit 20 is allowed to access the second memory device 34 so as to generate the second data signal and transmit it (st7). It should be noted that the authentication key contained in the second request signal may reflect price of the corresponding multimedia contents data. The mobile terminal 40 may put the authentication key into the second request signal based on the price information of the multimedia contents selected by the user only when the balance of the authentication information is sufficient. When the transmission of the multimedia contents data is completed, the price of the corresponding multimedia contents data is subtracted from balance.

On the other hand, if there is no valid authentication key n the second request signal, the authentication unit 32 of the tag 2 prohibits the tag control unit 20 from accessing the second memory device 34 in order to avoid generating the second data signal (st9).

When the authentication request signal is responded, the mobile terminal 40 prepares electronic payment (st10). For example, the mobile terminal 40 may display a separate message window for asking the electronic payment, or await selection of the user by automatically connecting to the server unit 60.

Accordingly, when the user selects the electronic payment, the mobile terminal 40 connects to the electronic payment server 62 of the server unit 60 via the Internet to process the electronic payment (st11). When the electronic payment is completed (st12), the authentication server 64 of the server unit 60 generates authentication information containing a valid authentication key and a balance, which will be downloaded to the mobile terminal 40 via the Internet (st13, st14).

As a result, the user can receive desired multimedia contents data from the tag 2 without restriction and store it in the mobile terminal 40, so that the purchasing of the multimedia contents is completed. On the other hand, the user input information for the electronic payment using the mobile terminal 40 during the above process may be stored in a separate database, or the mobile terminal 40 may store security information such as a public key for more secure electronic payment. While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, the present invention proposes a method of efficiently managing large scale multimedia contents using a radio frequency identification (RFID) technology.

According to the present invention, an RFID tag is used as a storage medium for large scale multimedia contents. Also, efficient authentication and application methods are proposed by selectively using a tag ID and a contents ID. Also, a wireless communication system and method for large scale multimedia contents using the same is provided. As a result, a novel electronic commercial trade can be facilitated.

Particularly, according to the present invention, users can conveniently receive and enjoy large scale multimedia contents stored in the RFID tag using their own mobile terminals.

What is claimed is:

1. A radio frequency identification (RFID) tag transmitting first and second data signals in respond to first and second request signals transmitted from a reader device, the RFID tag comprising:
a wireless communication unit transmitting/receiving the first and second request signals and the first and second data signals;
a first memory device storing first data for the first data signal;
a second memory device storing second data for the second data signal;
a tag control unit which generates and transmits the first data signal based on the first data in response to the first request signal from the reader device, or generates and transmits the second data signal based on the second data in response to the second request signal from the reader device; and
an authentication unit selectively prohibiting the tag control unit from accessing the second memory device depending on authentication information contained in the second request signal.

2. The RFID tag according to claim 1, wherein the authentication information is an authentication key including at least one of a tag ID and a contents ID; the authentication unit allows the tag control unit to access the second memory device if there is the authentication key in the second request signal; and the authentication unit prohibits the tag control unit from accessing the second memory device if there is no authentication key in the second request signal.

3. The RFID tag according to claim 2, wherein the authentication unit allows the tag control unit to transmit to the reader device an authentication request signal including at least one of a tag ID and a contents ID if there is no authentication key in the second request signal.

4. The RFID tag according to claim 1, wherein the second data is large scale multimedia contents data, and the first data is identification data capable of identifying the multimedia contents data.

5. The RFID tag according to claim 4, wherein the large scale multimedia contents data is at least one selected from a group consisting of music, videos, pictures, and data files.

6. The RFID tag according to claim 1, wherein the wireless communication unit, the first memory device, and the tag control unit constitutes a main body, the authentication unit and the second memory device constitutes an extended body, and the extended body is connected to the main body in a detachable manner.

7. A wireless communication system of large scale multimedia contents using the RFID tag according to claims 1, the system comprising:
a mobile terminal having:
the reader device;
an Internet communication unit for supporting access to the Internet;
a reader control unit for controlling communication between the reader device and the tag; and
a reader memory for storing the second data to be transmitted to the tag; and
a server unit having:
an electronic payment server connected to the mobile terminal via the Internet to support electronic payment using the mobile terminal; and
an authentication server operated in connection with the electronic payment server to issue authentication information for the electronic payment and transmit the authentication information to the mobile terminal via the Internet.

8. The wireless communication system according to claim 7, wherein the mobile terminal includes at least one selected from a group consisting of a personal digital assistant (PDA), a notebook computer, and a mobile phone.

9. The wireless communication system according to claim 8, wherein the server unit further comprises:
a web server connectable to the mobile terminal to provide a webpage for the electronic payment; and
a database operative in connection with the authentication server to store electronic payment information on the mobile terminal and a user of the mobile terminal.

10. A wireless communication method of large scale contents using a mobile terminal having a reader device, a tag communicating with the reader device on a radio frequency signal for storing first and second data, and a server unit connected to the mobile terminal via the Internet to support electronic payment, the method comprising:
(a) the tag storing the first and second data;
(b) the reader device detecting the tag and transmitting a first request signal;
(c) the tag transmitting a first data signal based on the first data in response to the first request signal;
(d) the reader device transmitting a second request signal; and
(e) the tag selectively transmitting the second data signal based on the second data depending on whether or not there is authentication information in the second request signal.

11. The wireless communication method according to claim 10, wherein the (e) transmitting the second data signal includes transmitting the second data signal based on the second data when there is the authentication information, or transmitting an authentication request signal when there is no authentication information.

12. The wireless communication method according to claim 11, wherein, when there is no authentication information in the second request signal, the (e) transmitting the second data signal includes:
(f) connecting the mobile terminal to the server unit; and
(g) the server unit generating the authentication key through the electronic payment using the mobile terminal, and transmitting the authentication key to the mobile terminal via the Internet.
